(19) United States
(12) Patent Application Publication
(10) Pub. No.: US 2013/0346226 A1
(43) Pub. Date: Dec. 26, 2013

(54) SYSTEMS AND METHODS FOR EVENT PLANNING AND PARTICIPATION AND A BALLOT PLATFORM FOR TRANSACTIONS FOR GOODS AND SERVICES

(71) Applicant: Robert F. Nunes, New Bedford, MA (US)

(72) Inventor: Robert F. Nunes, New Bedford, MA (US)

(21) Appl. No.: 13/926,628

(22) Filed: Jun. 25, 2013

Related U.S. Application Data
(60) Provisional application No. 61/710,377, filed on Oct. 5, 2012.
(60) Provisional application No. 61/663,986, filed on Jun. 25, 2012.

(51) Int. Cl. G06Q 30/06

(52) U.S. Cl. CPC G06Q 30/0605
USPC 705/26.2

(57) ABSTRACT

A website provides facilities for organizing an event including location, time and date selection, performer selection and promotion. Users can present themselves as performers for selection by an event organizer for an event performance. Users at the event are permitted access to the website to upload recorded media from the event, which can be live streaming content. Users can comment on the event in association with the uploaded media. Previous event recordings and comments can be archived for later viewing. Users can rent and selectively send/receive media to/from other users. A VIP event purchase option is available for groups to register to attend an event. The website permits product and/or service purchases, such as event ticket purchase, where the event need not be organized through the website. Users may be granted special status as regular commentators.

### STATEMENT REGARDING FEDERALLY SPONSORED RESEARCH OR DEVELOPMENT

(Not Applicable)

### BACKGROUND

The present disclosure relates generally to event planning and participation and more particularly to organizing events at which participants can create upload, and stream videos.

Social network websites, as well as media-sharing websites tend to be focused on sharing media among participants. Sometimes, certain participants in such websites can provide event announcements. However, there is no presently known single website and/or application facility for permitting participants to collaboratively and interactively organize, promote and hold an event, at which participants can provide media recordings for promoting and memorializing the event and streaming for others that access the website facility.

### SUMMARY

Briefly stated, there is provided in accordance with the present disclosure a website and application that provides facilities for organizing an event including location, time and date selection, performer selection and promotion. The website and application permit performance attendees to upload video from the event, stream live video or provide other media material related to the event. The website and application allows non-attendees to have live streamed access to the event, which access can be provided for a fee. The fee can be divided or distributed to the website operator, event planner, promoter(s), performer(s), and/or event location facility/business. The website and application also provides facilities for spontaneous, unplanned, in person, social engagements. The website can be implemented on one or more servers and/or in a distributed computing environment that can share resources and input/output, sometimes referred to as cloud computing.

An attendee of the event can provide media recordings to the website for other associated users to access. Users can present themselves as performers, a business (e.g. restaurant, venue), or public figure for selection by an event organizer for an event. Users at the event are permitted access to the website to upload recorded media from the event. Users can comment on the event in association with the uploaded media. Previous event recordings and comments can be archived for later viewing. Users can rent or purchase and selectively send/receive media to/from other users. Users may select or negotiate options that a business, performer, or public figure offers, such as VIP/group packages, and/or product purchases through the website. A VIP event purchase option is available for groups to register to attend an event. The website permits product purchases, such as event ticket purchase, where the event need not be organized through the website. Users may be granted special status as regular commentators.

According to an aspect of the disclosure, users can create or manipulate items on the website or application that can be used to communicate with other users. The items can be used to register interest or attendance for an event, to promote an event or to notify other users of specific events that may be individualized or intended for a limited group of users.

### BRIEF DESCRIPTION OF THE SEVERAL VIEWS OF THE DRAWINGS

The disclosed systems and methods are described in greater detail below with reference to the accompanying drawings, in which:

FIG. 1 is a simplified diagram of a webpage in accordance with an exemplary embodiment of the present disclosure;

FIG. 1A is a flow chart illustrating a process for renting and sending/receiving media in accordance with an exemplary embodiment of the present disclosure;

FIG. 1B is a flow chart illustrating a process for VIP event reservation in accordance with an exemplary embodiment of the present disclosure;

FIG. 2, composed of FIGS. 2(a) and 2(b), is a flow chart illustrating video sharing in accordance with an exemplary embodiment of the present disclosure;

FIG. 3, composed of FIGS. 3(a), 3(b), 3(c) and 3(d) is a flow chart illustrating event organization management in accordance with an exemplary embodiment of the present disclosure;

FIG. 4, composed of FIGS. 4(a) and 4(b), is a flow chart illustrating a notification process of a potential event participant in accordance with an exemplary embodiment of the present disclosure; and

FIG. 5 is a diagram illustrating an exemplary embodiment of operation of a ballot bidding model.

### DETAILED DESCRIPTION

This application claims the benefit of U.S. Application No. 61/663,986, filed Jun. 25, 2012 and the benefit of U.S. Application No. 61/710,377, filed Oct. 5, 2012, the entire contents of both disclosures being hereby incorporated herein by reference.

Event Planning and Management

The present disclosure provides systems and methods for implementing a platform for event planning and participation by a number of users, some of which may be specifically categorized, such as by being registered or account holders. The platform can be web and mobile application-based, so that users can access the platform via the internet to plan or participate in events or experiences. For example, the platform can be referenced with the URL MyFreakinParty.com. The platform can be implemented on one or more servers and/or in a distributed computing environment that can share resources and input/output, sometimes referred to as cloud computing. The platform can store user information, including information on event organizers or attendees, as well as information about performers, businesses, and public figures in a user profile, for example. Stored user information may be referenced by an account that the user can access with an account ID and password, for example. The stored user information may include associations with other users or groups of users, which may sometimes be referred to herein as “friends” or groups of friends. A user can define friends or groups of friends to permit the definition of special relationships between the user and the friends or groups of friends. Such definitions can be stored in association with the user profile, and may be derived from other sources, such as other social networks. The platform provides a facility for defining and storing relationships with other people or other users so that shared experiences or events can be setup based on selected relationships with other people, or with other users of the platform.

One purpose of this platform is to create a simple means to share an experience within a group of friends with other friends or all users who may or may not be physically present at the event or experience, and to do so in real time and place (at the event or experience). The platform can be a web-based application that permits access by a number of users over the internet. Users can access the website and upload or download content using a client device, such as a PC or a mobile communication device, such as a mobile phone. According to an exemplary embodiment, a user performs a series of functions, which can be governed to be performed in a predetermined sequence, with an application using a mobile phone, a website using computers, video recording hardware, and/or wireless internet, for example. Friends or users who are not physically present at the event or experience may view and interact with content that is representative of the event or experience through a computer or mobile device, for example. The users can provide natural audio recording feedback to the platform after the event or experience occurs, or during the same, e.g. in post or realtime (live). Natural audio recording refers to the facility often provided by a client device to make audio recordings of realtime events. Users share media recordings via the internet which promotes the purchase of live event streams broadcasted by the event organizer, performer(s), and/or location facility/venue.

This platform, or the operator of the platform, referred to herein as My Freakin Party (MFP), also provides a facility to search for performers or performances for creation of an event or experience in which users can participate. For example, MFP permits performers to register, such as by providing stored information in a profile a user can access and modify. A performer can register with MFP to create a profile that provides information about the performer or services offered by the performer. MFP thus provides a facility for any individual or business to search for any registered performing artist, entertainer, group, band, singer, DJ, dance group, comedian, musician, etc., and to book/reserve the performer(s) based on the performer's geographic schedule, for example. A performing event search at MFP is efficient because the search is tailored to the user's interest due to a series of user interest questions posed to the user at account registration, the user answers to which are stored in association with the user profile, for example.

Businesses and organizations may also promote and sell tickets for scheduled events through the MFP platform. Some examples are sporting events/games and large concert production companies may benefit by using MFP's unique promotion tools and techniques. In other words, MFP is not limited to promoting and selling tickets to events initially organized and scheduled on the MFP website, and permits access to events as an event portal, for example.

The MFP platform has at least three significant purposes. One is to create a fun and easy way for users who are not physically present at an occasion of interest to be able to enjoy and interact with that experience in a remote location. Secondly, a group of friends can share the expense of a VIP reservation prior to the event, such as by equal divisions for example. Thirdly, users can simply and/or easily create an organized party with a professional performer(s) in an affordable fashion while maximizing sales revenue and exposure for the performer(s) in an efficient manner.

It should be appreciated that the MFP platform can be implemented on one or more social media websites. The MFP platform can also be implemented as a standalone website with links to social media websites. For example, the MFP platform can utilized logins for or from other social media websites to permit users to interact with the MFP platform and the other social media websites concurrently.

User Account Profile

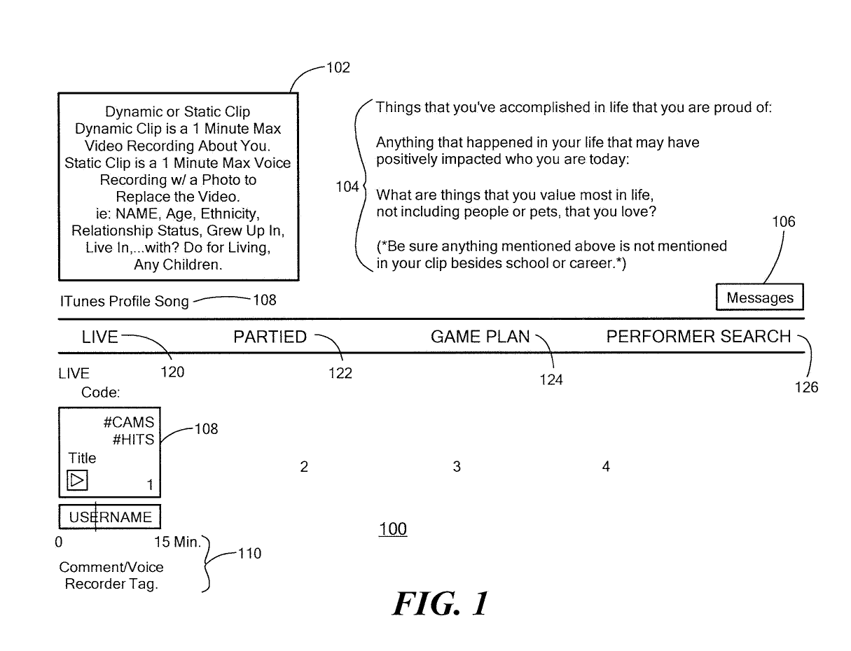

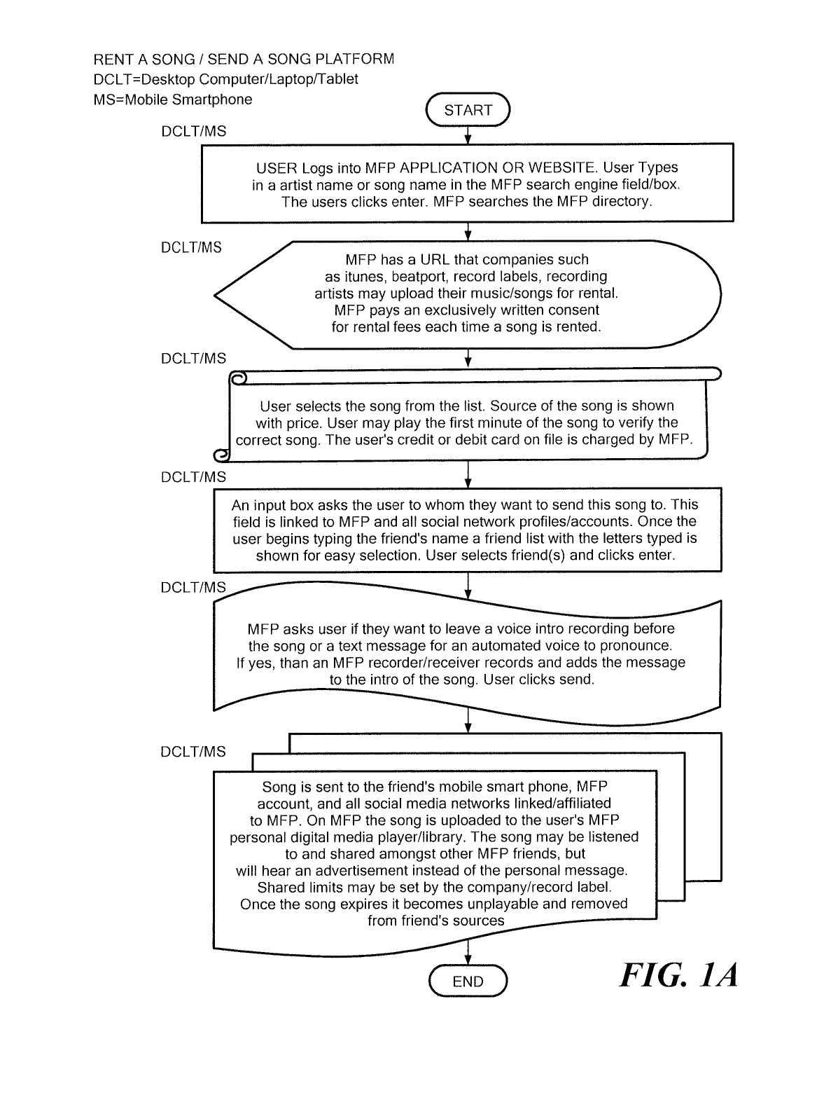

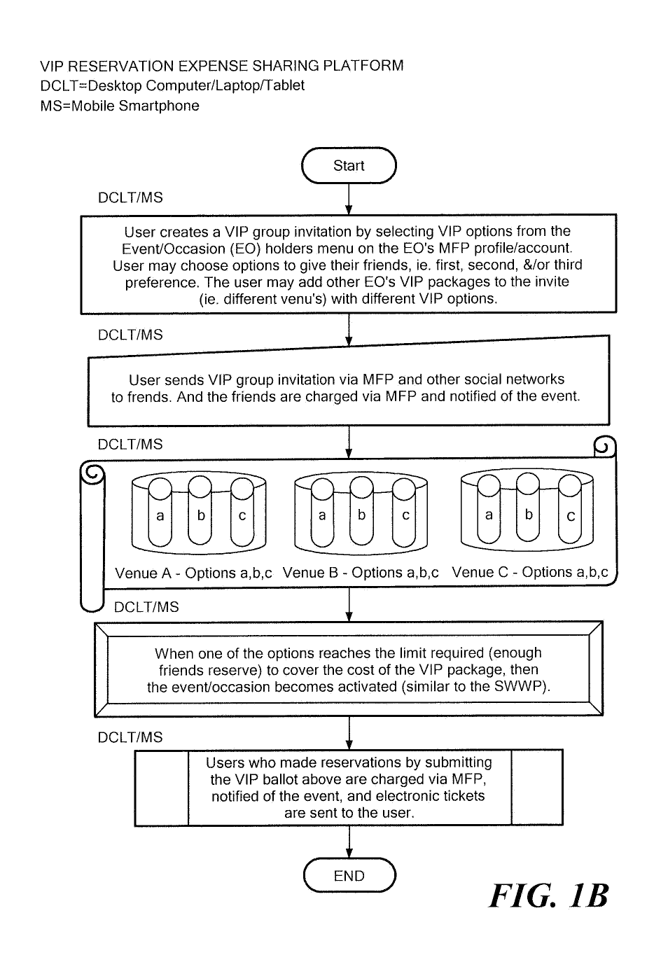

Referring to FIG. 1, at the top left corner of a user's front page 100 is a one minute static or dynamic personal clip 102 about the user. A static clip 102 can be a photo of the user with an actual voice recording of the user's name, age, ethnicity, relationship status, city or town/state where the user grew up and/or where the user currently lives, occupation, children, etc. A dynamic clip 102 is the same voice memo of the static clip 102 with a video recording of the user in addition to or as an alternative to a photo. On the right side of personal clip 102 users may choose and short answer three character questions 104 from a list provided by MFP that can help other users learn more about them. A message inbox and photo library is also included, which can be accessed via a button 106. Underneath the personal clip a media player 108 is displayed, such as an iTunes®, Beatport®, Soundcloud®, Pandora®, Spotify®, SiriusXM® or MFP player. Media player 108 permits users to upload and play their favorite account profile song, playlist, or station when one enters their page. The music plays lightly in the background while the personal clip is playing, for example, then the volume can be turned up after the personal clip is done playing. If a video clip is played from a library (discussed in greater detail below), then the personal itunes song pauses, then continues when the video clip is stopped or is done playing.

Rent a Song/Send a Song

Media player 108 can be configured to connect with and play audio from sources such as itunes, beatport, or other music content sources. Media player 108 can also be set to have a “home song” or profile song, which can be selected and played when the user or another user enters page 100. However, media player 108 can also serve as a personal digital mp3/mp4 library/player. Referring also to FIG. 1A, users can search for any song via title or artist name or other available criteria and either purchase and download the song or rent the song from the record label or content sources (i.e. apple with song rights) for a period of time. One purpose of renting a song is to send the song to a friend through mobile text messaging, MFP or a partnered social network website or application as a personal private message with a personalized recording discussed below. Lyrics to a song may serve as a personal message or may be intended to bring back memories amongst friends.

Rented songs may expire after a period of time. For example, a song can be encrypted with a key that can expire at the end of the rental period to prevent further access to the song. Accordingly, users can be prevented from permanently downloading and keeping the song. The cost and time of use of the rented song can be negotiated with record labels or other content sources. One goal for a rental song is for the cost of rental to be a small fraction of the download cost or full sale of the song. The rental fee can be automatically charged to the user's credit card through MFP or account balance on MFP, for example. MFP can manage rentals and charges and, for example, send a percentage of the user fee to the record label or content source, or collect a user fee from the record label or content source.

When a user sends a rented song to another user, a digital automated voice can be provided to announce who sent the song prior to the song playing. If another user who did not send or receive a song, listens to the song through MFP or any other social network affiliated with MFP, the automated announcement of who sent the song may optionally not play, hence the sender can remain private. Alternately, or in addition, an audio advertisement can replace the sender's name announcement when another user listens to the rented song. Therefore rented songs can be shared with friends, however in order to send a song, the sender or friends may be required to rent or otherwise properly acquire the song. When songs are rented and sent, they can be automatically sent to the receiver's mobile smart phone's message inbox application, for example, and may be played on the receiver's mobile smart phone. The song can also be saved on the user's MFP app, mp3/mp4 player/library 108. Once the song rental or usage expires, it can be automatically removed from the user's MFP account/mp3/mp4 player 108 on MFP website and smart phone application, for example. The sender may also voice record or text a message, which is announced by the MFP digital automated voice system, to play prior to the song playing. The message can optionally be limited to be no longer than one minute. This message can be set to remain private, such as with a particular code, and to only be listened to by the receiver with the code, for example. MFP users may also rent songs for their MFP music mp3/mp4 player library 108 on the MFP website/app without necessarily sending songs to another user.

Event Media Sharing Using an Event Code

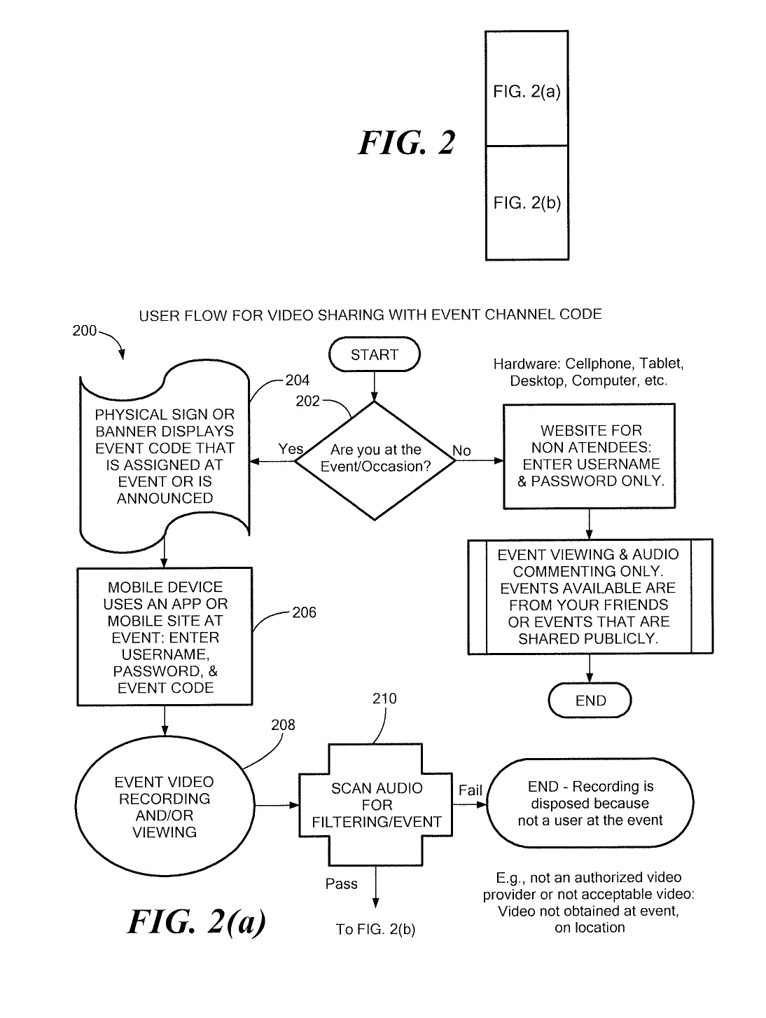

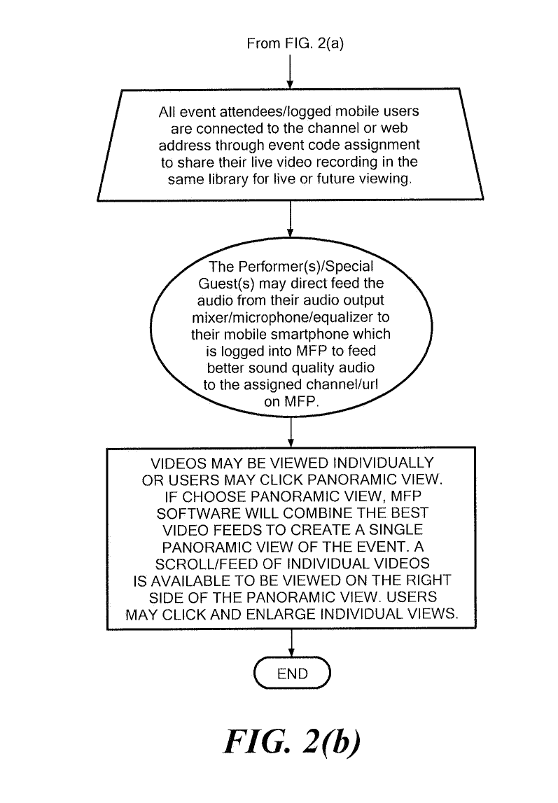

FIG. 2 is a flow chart 200 of the user flow during event channel sharing. A user that is at an event that has been previously registered with MFP can use an MFP application on their mobile device, for example, to log into their personal account with their username, password, and the event code that is assigned by the event holder, as indicated in block 206. For larger events, the event code can be displayed on location on a sign or banner. The event code gives access to a channel or web address/URL associated with the MFP platform, such as the MyFreakinParty.com domain, for example. The domain can provide a back end program that generates a new URL every time an event code is assigned to an organized party/event. The event holder is also known as the event organizer or the person/entity that scheduled, registered, set up the event, and/or promoted the event on the MFP platform, such as on the MyFreakinParty.com URL, for example. The event holder can assign the event code on the day of the event, and may optionally be limited to only that time frame for obtaining or assigning an event code. The event code can be created by the event holder and/or by a back end program that searches the MFP platform, including, for example, the URL directory to verify that the event code is not in use. Event codes can be recycled after 24 hours.

After a user who is at the event logs into their personal account using the event code, as indicated in block 206, that user may click on the record button and begin archiving media onto the assigned channel/URL of that specific organized event, as indicated at block 208, or the user may post the recorded video on other social media networks. It should be understood that the recording can be or include any type of media, including video, tactile, audio and photographic, as examples. Depending on the “organized event” privacy settings of the user, such as may be set in association with the user profile, their recording(s) may be viewed by users outside of their friend network.

After recording, the media clip filters through a security program that matches the audio to verify that the user is at the event, as indicated at block 210. This scanning technology performs the same way as Shazam™, for example. The audio is matched to the audio of the event holder. The event holder's MFP application performs an audio ping every 10 seconds, for example. If the user's audio fails to match the event holder's audio ping, at the same recording time, then the security program can verify the user's audio by matching at least two users who have previously successfully matched the event holder's audio ping. Another form of verification may be made by pinging the GPS location of the event location with the user's mobile device. Once verification is successful, then the video is added to the event channel/url where it is available to be shared for viewing and audio commenting for non-attendees as indicated at block 212, or it may be shared immediately after recording via the MFP mobile application and shared on various social media networks. If the verification is unsuccessful, then video may not be added to the event channel/url or shared/posted to social media networks, or may be excluded from such media. The unverified recording may be disposed of as not being an authorized video taken on location at the event while the event is in progress. Accordingly, the security program is intended to permit upload of videos taken on location at the event while the event is occurring by analyzing and matching the audio component of the event with other trusted audio feeds from the event. As part of the security program operation, the event holder or authorized agent or representative can provide live audio of the event on site to permit matching with other audio components of videos that are attempted to be uploaded to the platform.

The Event Holder, Performer(s)/Special Guest(s) (P/SG), public figure, or location facility/venue may direct feed the audio from the P/SG audio output mixer/microphone/equalizer to their mobile smartphone which is logged into MFP to feed better sound quality audio to the assigned channel/url on MFP.

Videos may be viewed individually or users may select (click) a panoramic view. Prior to or when a user chooses the panoramic view, MFP software combines the best video feeds, as determined by the MFP software, to create a single panoramic view of the event. For example, the best video feeds may be determined based on clarity, stability or proximity to a given item at the event, and may be assigned a ranking accordingly. Videos with a certain ranking may then be used to create the panoramic view. A scroll/feed of individual videos is available to be viewed on the right side of the panoramic view. Users may click and enlarge individual views.

The uploaded media may be restricted in length to one to two minutes, and may serve as promotional items for promoting the live performance or a full recording of the live performance. In the case of a live performance, users can access the website to see the promotional clips and can choose to receive a media stream from the event or performance. The media stream can be authorized by the performers, agents, sponsors or event organizers, and the accessing users may pay a fee to see the live media stream. Similarly, an authorized recording of the event or performance may be viewable by users for a fee. The promotional clips obtained by persons at the event or performance can be shared using social media websites such as Facebook or Twitter, which sharing of clips can include links to the media stream viewing/purchase website or the recorded media viewing/purchase website. Such viewing/purchase websites can also be hosted on social media websites.

Audio and Text Commenting

Referring also to FIG. 1, below each video recorded image 108 is the audio commenting player 110. Player 110 is a dynamic text/font image of the user's username that is audio commenting about the video. The text/font image changes to the username of the person giving the pre-recorded audio comment. A needle moves across the username text/font image to give the user a visual measure of the total recorded time. A drop down menu and roll over list is present to allow the user to see the usernames who have commented which allows them to click and skip to listen to the comments of the user that interests them. Users may also text comment on videos or pictures instead of audio commenting.

Event Non-Attendees

Non-Attendees may log into their account using any device that has internet access. The front page 100 of their account gives them access to a video library, or a series of columns/rows of video clips. A navigation bar organizes the library into four sections, which can be implemented as separate pages or series of pages:

1.) Live

2.) Partied

3.) Game Plan or Discover

4.) Performer Search

A Live page 120 provides a feed of video streams that are occurring live. The page displays the live video streams of the friends that the user has most recently interacted with and/or friends who have interacted with the user. The second order of display priority is Live Organized Performer Events and Live Organized Non Performer Events by friends of the user. However, a drop down list menu allows the user to sort the live video streams by:

1.) Friends-Most Interactive
Check box—with performance. Check box without performance. Check box—both

2.) Friends-Closest to home

3.) Public—Most Interactive based on user interest

4.) Public—Closest to home

5.) Public—Most Interactive

SEARCH BOX ON PAGE

1.) Public—Type in Performer(s) name

2.) Public—Town/City, State/Province, Country

The search engine input boxes finds live public streams with the terms that the user can enter in the title of the stream. User preferences for video classifications, such as live public video streams, can be stored in association with a user profile, along with a history of a user's interaction with videos or other users or people. A backend algorithm can use the stored preferences or history to display video streams that may be of interest to the user based on the user's interests and/or interaction history. In addition, the user can search for videos, using such criteria as classifications, such as live video streams, and the user may sort live streams based on the fields mentioned above or their own custom search requests. The number of users that video record an occasion or event is displayed at the top right hand corner of the stream and/or video image, for example. Also the quantity of audio recorded comments or voice interactions is displayed beneath the number of users that video record the occasion or event.

A Partied page 122 is an archive of all the video recordings that are recorded or saved dated chronologically. The videos are divided into 3 separate exemplary categories:

1.) Non-Performer

2.) Performer

3.) Favorites (Favorites may also include videos that any MFP user recorded and allowed sharing rights.)

Interactive audio comments are shown and made accessible to be replayed in the future, e.g., after the event. Users may make audio comments at any time in the future, e.g., after the event. Users who have made an audio comment on a photo or video recording can be notified each time a user submits a comment, such as by being sent a text message or e-mail.

Partied page 122 also archives photos that may be uploaded of the occasion or event. Audio comments may be made and archived for the photos taken during the occasion or event.

A Game Plan or Discover page 124 allows the planning, promoting, general admission ticket sales, and/or VIP table/area reservation sales of any occasion or organized event which automatically goes live on the day of the event. These events, occasions, notes, or comments may be shared with a user's friends in the user's network by posting to a Chalk or Dry/Erase Board page, which can also be implemented as an application specific feed, e.g., an MFP Feed, or to other social media networks/websites/applications (not shown). Page 124 shows plans that friends have scheduled and all events/occasions that a given user has been invited to. This (these) page(s) can display all the planned ballots, and permits audio, video and/or text comments to be made on each ballot. The term “ballot” is used here in the ordinary meaning of the word, as well as to identify features of the present disclosure, as are further discussed in the MFP Strategic Win-Win Platform below.

Each performer/special guest may submit an audio, video, or text comment to be featured on the ballot. An organized event or occasion may or may not include professional performing act or special guest. A list of local occasions or events with number and gender of friends that may attend is displayed. If performance organized events sell tickets at the door only, then reduced tickets may be sold through MFP Ballots. The MFP application of the present disclosure allows a paperless matrix bar code ticket to be sent electronically to the user's mobile device. MFP occasions or events become visible via flyers and ballots on the Live feed or shared on various social media networks to other users (e.g., those not in attendance) if live recordings or other recordings or uploaded photos are taken. The term “flyer” is used herein in accordance with its ordinary meaning, in addition to being used to identify certain features of the present disclosure, described below in greater detail.

If a recording takes place prior to the event start time the recording may remain on the live feed as “Pre-Game Recording for ‘Title of Event.’” The event code is messaged to the users who have purchased tickets or VIP packages via the ballot to the occasion on the day of the event, e.g., in the morning of the event. Pre-Game recordings of an event are archived separately from the actual event or occasion. After the planned occasion or event goes live and ends, any video recording of that occasion is automatically saved in the “Partied” archive. If no videos are recorded or photos are taken of the planned occasion or event, then all information that is logged may be deleted and/or recycled. There is an “invite all friends” radio button to send the ballot to the friends defined in a user's network. Friends may also be selected/invited individually.

The Game Plan page or Discover page 124 can also include a search engine box to help users find and buy tickets/ballots, or live streams to performer(s) organized events. The back end algorithm automatically finds events that may most interest the user, e.g., based on profile-associated information as discussed previously.

VIP Reservation Expense Sharing Platform

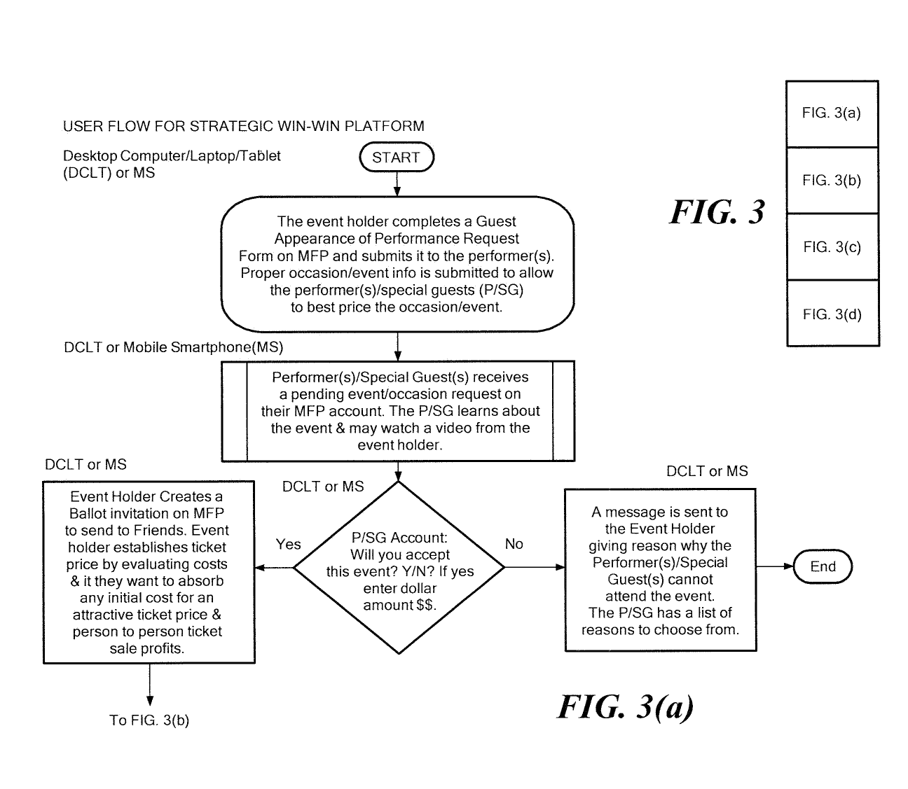

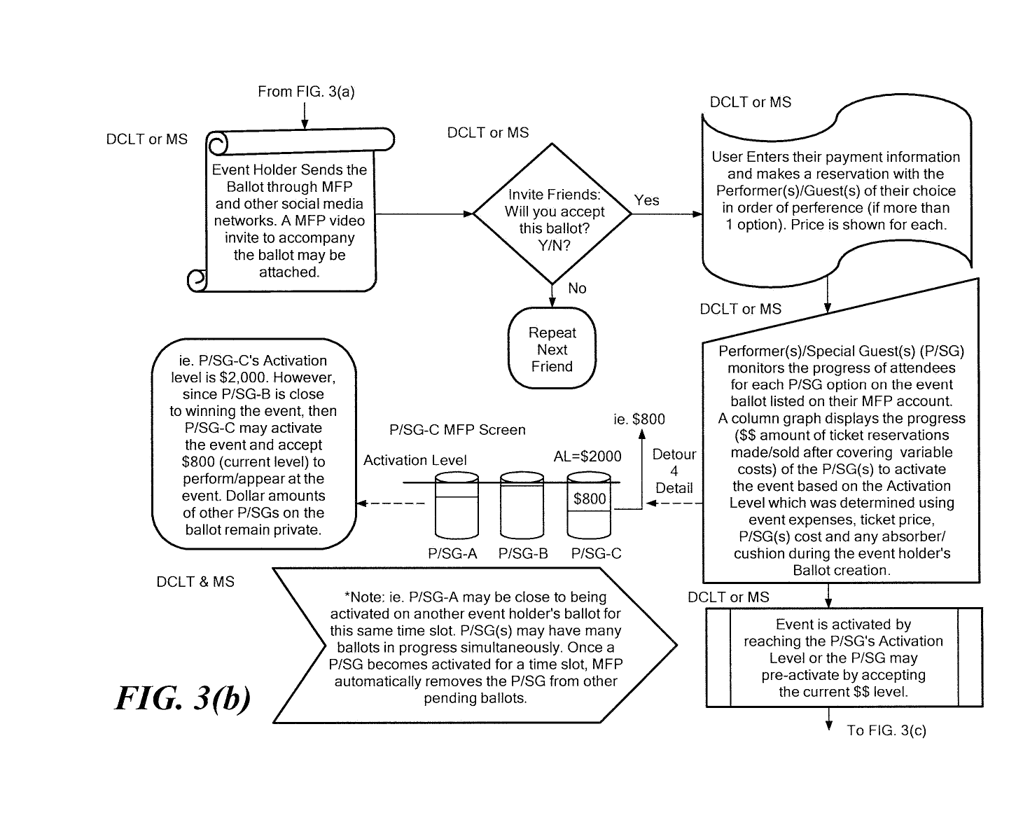

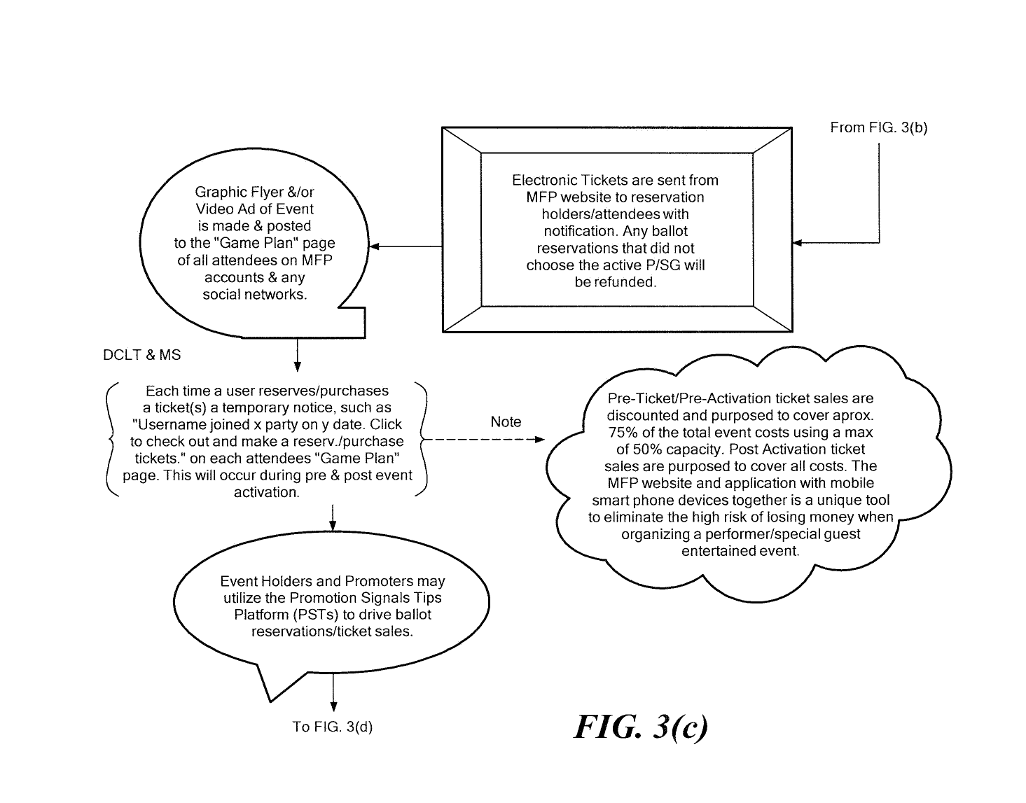

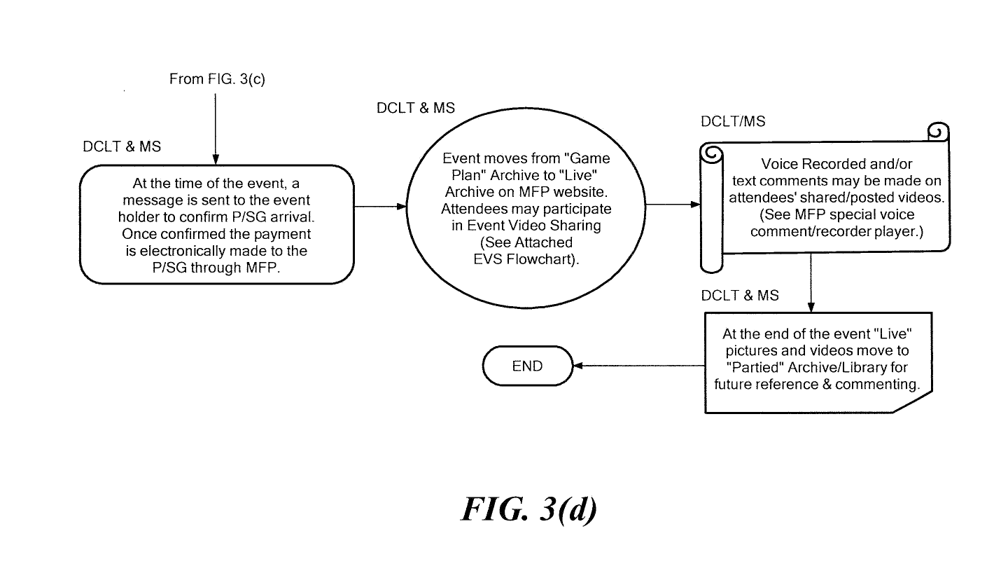

On the ballot, (See Strategic Win-Win Platform Flow Chart, FIG. 3 and VIP Reservation Expense Sharing Platform, FIG. 1B) the dollar amount to reach the activation level may be reached faster if the Event Holders sells/activates VIP Packages. The attendee may purchase general admission or purchase a VIP package that the event holder may offer. If the attendee chooses a VIP package they may pay for it in full, or create an invitation to invite their friends and share the cost to purchase a VIP Package. VIP Packages can be implemented for groups of people. Attendees may use MFP to create an invitation to activate a VIP package once the set number of people accept the invitation (using their credit card information, e.g.) to cover the total cost of the VIP package including the gratuity, for example. The event holder may create a menu which is linked to the ballot/invitation and VIP guests (or any full service reservation) may order or choose food or beverages, through MFP (website or app), in advance (ballot/invitation) or during the event, without having to wait for their server/waiter/waitress. If additional food or beverages are ordered outside of what is included in the VIP Package (for an additional charge, e.g.), then each VIP attendee can be automatically billed separately for their additional orders. For example, VIP attendees can be billed through MFP using the same credit card used to make the individual's VIP reservation, or they may use any funds on their MFP account balance. The event holder may set restrictions on their VIP group invitation forms or ballots such as the ratio of males to females in VIP groups, for example.

Promotional Private Calls or Text Message (PPCT)

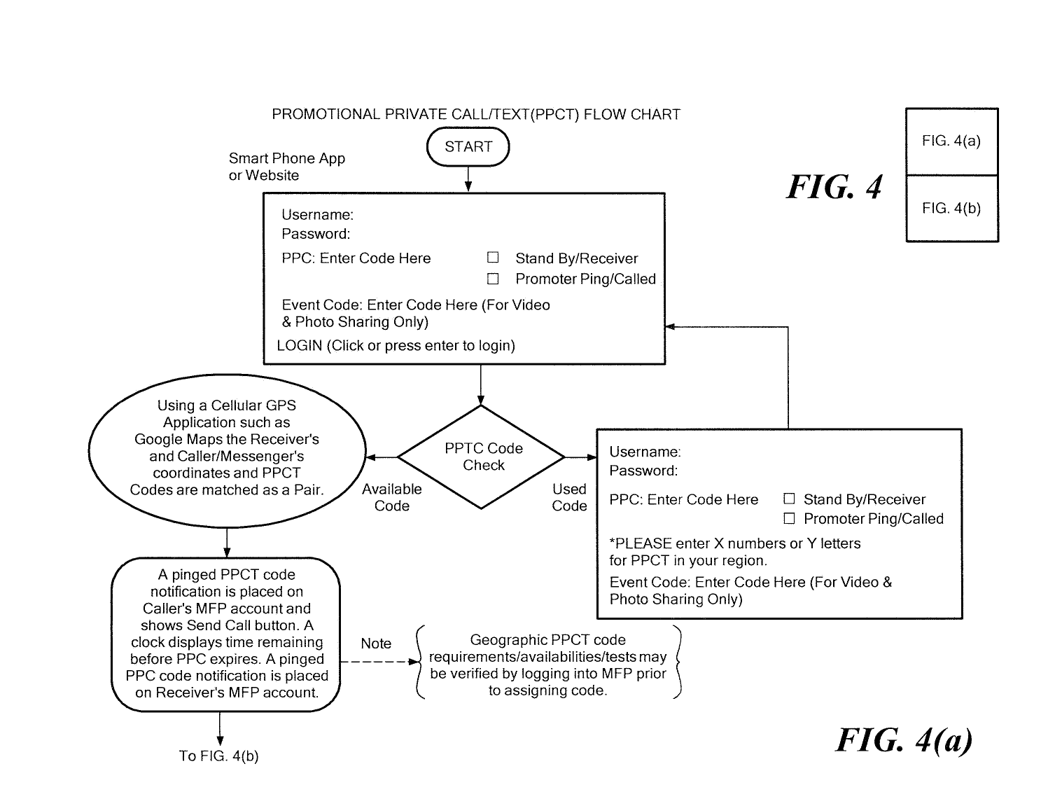

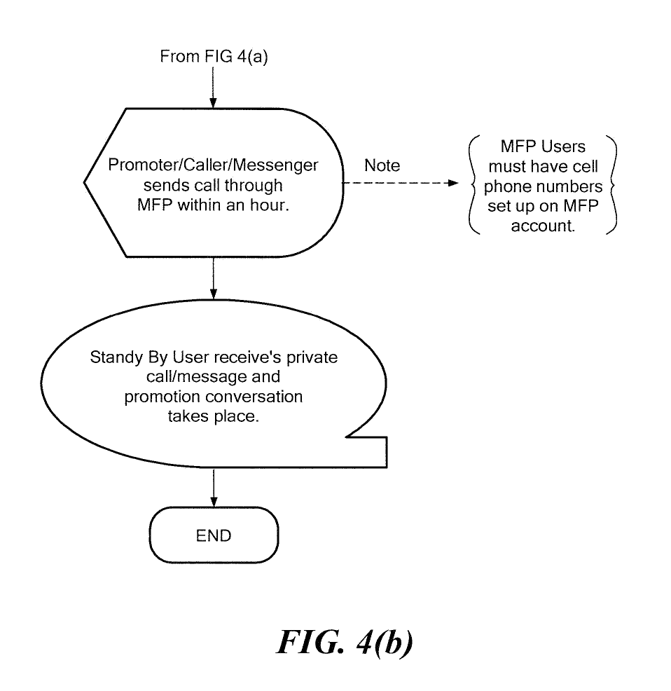

The PPCT is a signal with a self-created two, three, or four digit number code, and/or alphanumeric code depending on geographic activity, that allows the user to notify (e.g., privately call or text message) someone within a small or local geographical radius, to promote an event, without requiring their cell phone numbers. This system works by matching the user's pinged cell phone coordinates, such as may be obtained via an onboard GPS, (MFP may use Google® Maps) with the code that the user has signaled or told to the individual, for example (The digit requirement is displayed at the username and password login of MFP). In further detail, when the user logs into their MFP account, there can be a PPCT input box. The user enters the PPCT number code that is signaled or provided by the promoter and checks off Standby/Receiver and then Logs into MFP. The promoter/caller/sender performs the same steps, however checks off Promoter/Caller/Sender instead and then logs into MFP. Once both users log in, The MFP application uses a cellular GPS program such as Google Maps to match/ping the coordinates and the PPCT code of the two users and the MFP backend program immediately prompts the promoter to send the private phone call to the user/receiver on standby. It is important for both users to log into MFP as soon as the PPCT code is exchanged in order to lock in the private phone call and ensure a successful ping. The designated radius can vary depending on usage volume at the time and location. A PPCT submission can be set to expire after one hour, for example. Once the call is made the PPCT code is recycled and becomes available for other users to use within that geographic area. (See PPCT Flow Chart, FIG. 4).

MFP Stream Jockey Show

The MFP Stream Jockey Show permits an MFP user to attempt to host a Stream Show. The survival of the show is based on the number of listeners, reputation, and the Stream Jockey's record of following the MFP Rules and Regulations. Stream Shows may be hosted by popular users, such as, for example, friends voted to be the funniest friends within the network of friends, which is defined as a common relationship among a group of users. For example, a host or show may have the role to promote the performer(s) events within a geographic network and to have fun talking about any MFP videos from prior events. Another possible role is to also sample any of the work of the performer(s) to help promote upcoming events, for example, to stream any popular songs of the artist. It may be funnier to laugh to someone the user knows personally. Stream Jockey's may be paid by MFP based on how many tickets they sell of MFP performing events within their network. One benefit of MFP Stream Jockey shows is that users may listen to a familiar person and keep them in the loop of local events without necessarily actively participating, e.g., while driving a car or getting a dose of exercise.

Explicit Language and Content

An active/non-expired credit card or debit card may optionally be registered for users to have access to any explicit language or content that may be said or shown, e.g., presented, during Stream Jockey Shows or Live Performance Streams, etc. Explicit language and content can be monitored, controlled, and limited by MFP and limited to 18+ users, e.g. Users who exceed or abuse the limits can be warned and penalized accordingly, such as by receiving reduced service access.

Record Now

The front page may also have a Record Now button that allows live stream video sharing to friends for occasions that are not planned in page 124. These videos can be archived to the Partied video library or shared on other social media networks after being recorded.

The Strategic Win-Win Platform or Ballot

Ballots allow the planner to earn funding prior to the event while providing options for their guests when promoting on social media. One feature of the ballot model is the ability to bring together persons interested in a product or event/performance and sellers, event organizers or performers. The ballot model permits a seller, event organizer or performer to propose a product, event or performance to test the market demand for the item. The seller, event organizer or performer prepares a ballot for users to review and potentially select for acceptance. When user's select their option(s) on a ballot, they register their acceptance of the proposed item. According to an exemplary embodiment, the selection(s) do not become established or agreed upon (activated) until the planner has sufficient reservations made, for that option, to cover the designated expenses. Hence, the ballot feature allows the planner to manage their costs, and the expected payments, in accordance with market expectations and interest. The planner can then maximize the quality of the occasion while keeping within a budget to avoid losing money.

MFP allows more quality events to take place because it may eliminate the planner's risk by using ballots. For example, the planner may include a high end option for food, location, and entertainment. The benefit to the performer(s), special guest, or public figure of being on ballots is that it maximizes their revenue by booking private or public shows, or appearances that do not conflict with their existing bookings in the same geographic region, depleting their opportunity cost. Also, businesses on ballots, such as restaurants, can have a place to manage and negotiate large parties using social media.

One feature of the performer(s) and Event Holder Platform is to permit the performer(s) to maximize revenue by booking private or public shows or appearances that do not conflict with their existing bookings in the same geographic region. The use of the ballot feature opens new markets and generates revenue for performers or public figures by attracting new public and private events. The user can plan an occasion or event at a website, such as, for example, myfreakinparty.com by creating a ballot or flyer. The user invites and/or negotiates with performers, special guests/public figures, event locations, restaurants etc. and can invite friends and other individuals. Once the ballot is complete, the user can invite/negotiate via MFP or various social networks. Media may be uploaded on ballots as a feature. A video invitation option can be made available and be recommended for groups of users.

A user may see the performer(s)' availability in their geographic region by visiting the performer's MFP Calendar on their profile page and discover if the performer is accepting performance and/or guest appearance requests. This Strategic Win-Win Platform, or an inverse platform, e.g. inverse to an Ebay® and Groupon® modeled platform combined, is illustrated as a process in FIG. 3. The Strategic Win-Win Platform is a gauged dynamic. In other words, it measures the demand for the performer(s) prior to the event being scheduled or active. However, the demand can also be a function of the event holder and their promotion team to promote the event which can induce the activation level shown on the SWWP flowchart in FIG. 3.

The bidding model on a ballot in the Strategic Win-Win Platform can be used for price agreement based on the social media demand for the selling item (product, or service). For example, considering the performer as a service source, any type of goods or services can be sourced using the bidding model. Thus, the bidding model permits a seller (manufacture, distributor/retailer, or service provider) to easily compete for different types of consumers, such as low-end, mid-level, and high end consumers, online, through social media.

The Strategic Win-Win Platform uses multiple physical actions to permit users to put on an occasion (See SWWP Flow Chart, FIG. 3). In an exemplary embodiment the event holder completes a Guest Appearance or Performance Request Form on MFP and submits it to the performer(s) or special guest(s) (P/SG(s)) so that they learn about the event/occasion, accept the event with a price, or deny the event/occasion. If they do not accept the event then a list of reasons to choose from can be provided to check off and respond to the event holder.

The event holder can then create a ballot for the accepted performer(s) or special guest(s) with the event/occasion details, general admission prices, VIP package prices, etc. The event holder can decide if they want to absorb any initial cost for an attractive ticket price. The event holder's credit card can be charged via MFP for this cost or “cushion.” If the performer or special guest does become active to the event, then the event holder can automatically be refunded.

Once the ballot is complete the event holder can invite or share the ballot with friends through MFP and/or other social media networks. Friends then may reserve or purchase one or more options on the event ballot and may be provided with one or more options to choose their performer(s) or special guest in order of preference. If a user does not choose an option, such as a performer or special guest that becomes activated, then the user may not be charged, or can be refunded. The Performer(s) or Special Guest(s) can monitor the progress of attendees or the required cylinder volume fill on active ballots. Volume fill may be largely dependent on the VIP package sales because such sales are responsible for quickly increasing the funds that may ultimately activate the option on the ballot. In this way, the seller, organizer or performer can gauge interest in the product or service prior to committing to a sale, event or performance.

In one exemplary embodiment, the seller, organizer or performer may determine that there is less interest than expected in the product or service. In such an instance, the performer, special guest/public figure, or business on the ballot can choose to reduce the price of the offering. Alternately, or in addition, the offerer may choose to or offer to pre-activate the event while the ballot is still open and social media promotion is still ongoing. A facility is provided to permit the event organizer/planner to approve this request. Also, an event attendee may offer to pay the difference required to activate an option on the ballot. The option can be configured to not activate until the ballot creator/Event organizer approves the payment from an attendee or performer/etc. The ballot has a number of settings that can be selected when the ballot is created. For example, settings can be provided to permit the organizer's approval to be provided or withheld or to permit pre-activation, which shortens the timeframe for event activation. The ballot may also have settings to either reduce the per ticket price of the attendees or generate revenue for the event organizer if there exists a service price reduction or a boost in ticket sales from ballot activity, for example. In this way, the platform can find a satisfactory market for the goods/services being offered, to permit users to have efficient costs and valued products/services.

P/SG(s) may have many ballots pending at the same time. Once a P/SG becomes activated for a time slot that is shared on other ballots, then MFP automatically removes the P/SG from other ballots that are in progress. A P/SG may activate the event prior reaching their activation level by accepting the current dollar amount level shown/to be paid to the P/SG. In turn, the event holder may activate any P/SG by paying the remaining balance to activate the P/SG of their choice.

Once the event is active, electronic tickets can be sent to reservation holders/attendees. A Graphic Flyer and/or Video Ad can be posted on the “Game Plan” Page 124 (FIG. 1) of all attendees on MFP and other social media networks. Event Holder and promoters may use PPCs and other MFP tools to drive ticket or VIP package sales. On the day of the event, once P/SG arrival is confirmed by the event holder via a notification, such as by an electronic text message sent to the event holder's cell phone, payment can be electronically made to the P/SG through MFP and a message can be sent to the P/SG's cell phone confirming payment. The event goes “Live,” so that attendees may begin streaming/sharing video, as illustrated at the Live Page 120. At the end of the event, all the video and picture content that is shared amongst all attendees is moved to their partied archive 122 on MFP.

The bidding model in the Strategic Win-Win Platform allows a price agreement based on the social media demand for the selling item (product, or service). What makes this bidding model different is that it allows a seller (manufacture, distributor/retailer, or service provider) to easily compete for different types of consumers, such as low-end, mid-level, and high end consumers, online, through social media. The seller or source of the goods and/or services can promote sales by creating a ballot with one or more similar items, or the same item if the ballot consists of different distributors/retailers that sell the same item, competing in the same market. The ballot can be created by an administrator who works with the sellers. The ballot may be shared by any user and posted on their social media websites. The user can be provided with an online, website account registered with the administrator to participate in the ballot.

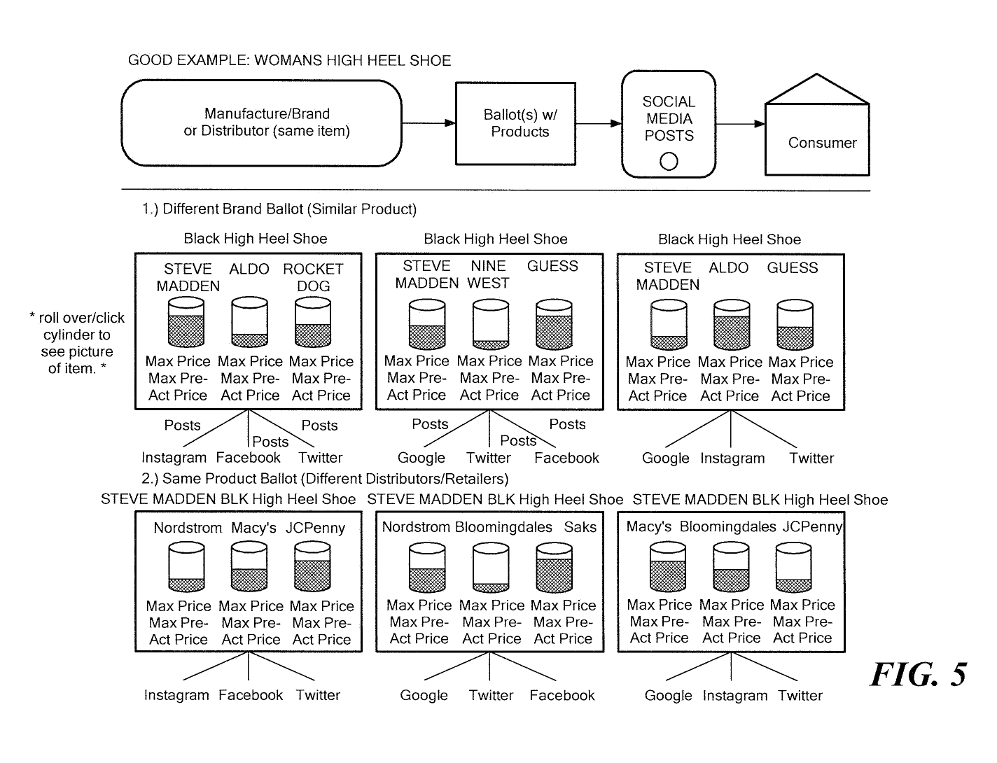

Referring to FIG. 5, an exemplary embodiment of the ballot displays a cylinder shaped scale for each item. Buyers select item(s) on the ballot they are willing to purchase. They see a picture and description of the item when they roll over or click on the cylinder. The cylinder is a visual measure of how many people have selected that item. Once a cylinder scale is filled, the item sells for the max price listed on that item. The first cylinder scale to be filled first earns all the buyers who have selected that item on the ballot. Buyers may select more than one item on the ballot. The winning item can be sold to the buyer, and other selected items may or may not be sold to the buyer. The losing sellers have the option to sell to the buyers who have selected their item, but did not select the item of the seller who won the ballot. The losing seller can sell their item at the max price discount, as if their cylinder had been filled and won the ballot.

If a seller sees less demand for their item, then they may choose to activate the sale prior to their cylindrical scale being filled, in which case their items may be sold for less. This is called pre-activation. A pre-activation discount is applied to the seller who pre-activated the ballot. This discount can be determined when the ballot is created and can be the same or different among the sellers. The pre-activation discount can be, for example, a fixed percentage discount such as 25%, which is discounted from the item of the seller who pre-activates prior to their cylinder being filled. As an alternative, or in addition, when the ballot is created, the sellers may choose to perform a percentage price reduction auction if the ballot is pre-activated; however the seller who pre-activates may have a higher percentage discount bid rate than their competitors. This bid rate can be pre-determined when the ballot is created, based on the quality differences of the competing items. For example, for every one percent discount bid that a seller raises, the seller who pre-activated can discount two percent to raise the discount bid. Since volume is sometimes lower during pre-activation, sellers are allowed to set their pre-activation price for their item higher than the max price when their cylinder is filled.

For goods, in-stock ballots means that sellers indicate that they have, in stock, the minimum quantity of items available required to fill the cylinder on the ballot. An administrator of this model can create the ballots by working with the sellers. A website can be configured to use this model and may include a platform that makes it easy for sellers to monitor or interact with the ballots on various social media networks. Also, sellers may have the same item on different ballots concurrently, thus permitting competing against different sellers of a similar item. However, for in-stock ballots sellers may be restricted from allocating more units on various ballots together than they have in stock. For example, if a manufacture has 1,000 units then the manufacture may allow 100 units to be sold on 10 different ballots or 1,000 units to be sold on one single ballot.

Pre-stock ballots may also be created. For example, the buyer understands that for some products or services there exist an 8-12 week delivery time for some or all items on the ballot because the items are made to order. Manufacturers or providers may offer a greater discount on items because there is reduced risk of disposing of inventory. In-stock and pre-stock ballots are color coded so that the buyer may easily distinguish the two.

For services a customer can develop a ballot with the job or service description. An administrator can be employed to find local contractors or service providers to participate on the ballot with the maximum price the customer is willing to pay for the job. Alternately, or in addition, contractors or service providers can participate themselves in the ballot bidding model. The contractors or service providers may down bid the job, however the customer makes the final decision on which contractor or service provider they want. A history and rating of the contractors or service provider's previous customer comments is saved on their profile.

All ballots are easily copied and shared on various social media networks and users receive incentives to post ballots on their social media profile, such as by being able to accumulate points to receive an additional discount on their next purchase.

Features:
If a buyer posts the ballot on their social media platform then they may receive free shipping or a voucher/reimbursement on their winning item.
A Nightclub may offer a voucher worth a certain amount of dollars at their venue for less expensive performers on a ballot.
Sellers may sponsor celebrities or fashion icons to post ballots on their social media websites/networks such as Facebook®, Twitter®, Google®, Myspace®, or Instagram®.

As discussed herein, a flyer is a tool for the everyday social media user. Flyers can be based on purchases or money exchanges, however, the basic intent of a flyer is for communication on a non-payment basis. For example, a flyer can be created to post and discover persons that desire or agree to go together for a dinner, a game or a movie. A flyer can also be used to seek advice, e.g., what shoes should the poster should buy, or to generally communicate regarding a topic or them. Flyers can be used as invitations, for example, such as by providing a facility to announce an intention to go for a beer with the poster at a certain place at a certain time, e.g., at 8 pm.

The flyer may tally graphic results like the ballot described above, and can be configured to implement permissions for results. For example, the results can be tagged to limit access to users that have a matching tag, such as an administrator. Using such a configuration, or other like functionality, such as access control lists (ACLS), the feedback on a flyer can be made private between the person that posts and the person(s) that respond(s). A flyer can be used as a type of forum, which can permit public discussion. However, it is intended to be generally used as an attractive media tool to promote and implement physical, social engagements, meeting places, asking questions, or getting opinions. For at least those reasons the feedback can be made private once it is posted on MFP or onto social networks. It is intended that the flyer and the ballot operate separately and fulfill different distinct functions. The flyer permits responses to be in any useful media, including voice, recorded messages or text.

Revenue

MFP Revenue streams are from ticket (ballot) sales & fees, performer(s) or special guest(s) booking transaction fees, commercial advertisement, a percentage fee for the transaction of VIP package sales, food, beverage and spirit sales, all through the MFP website and/or application using a mobile smart phone device, computer, laptop or tablet, as examples. Another source of revenue is song mp3 downloads or song rentals from Rent A Song/Send a Song.

MFP can generate revenue from the use of ballots and flyers by a graphic frame or border of the brand (paid advertisement) that may match the color scheme that the user chooses when creating the ballot or flyer. If the user chooses to add a video or a voice recording to the ballot or flyer, then a paid commercial advertisement can be played. If the user wants to pay a one-time or monthly fee, then no advertisement is shown or played on ballots and/or flyers.

Another source of revenue generated with the Strategic Win-Win platform is licensing fees and percentage fees assessed to the buyers, sellers, and administrators, on the sales of the products or services that use this model. This model also earns a percentage on advertisement fees that is earned by administrators or sellers. This model also earns a percentage of sponsor endorsements that use ballots on their social media networks.

MFP can generate additional revenue by a percentage of the pay per view, live event video streams broadcasted by performers, artists, musicians, public figures, special guests, event facility locations/businesses, and/or promoters, etc. Businesses may also pay MFP for search engine advertisement when users create an event. MFP can receive a percentage of the performer(s), special guest/public figure, or business, fees charged to the event planner through the ballot

Commercial advertisement consists of Audio or Video before streams or recordings through/on MFP. Audio Commercials played before a song is played by a third listener with Send a Song™, video commercials that are played before videos that are shared with MFP. Revenue is also generated from commercial banners and graphic images that may be displayed on the MFP website.

The operations herein depicted and/or described herein are purely exemplary and imply no particular order. Further, the operations can be used in any sequence when appropriate and can be partially used. With the above embodiments in mind, it should be understood that they can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the functions described herein may be performed by a processor executing program instructions out of a memory or other storage device. Therefore, it is the object of the appended claims to cover all such variations and modifications as come within the true spirit and scope of the disclosure.

What is claimed is:

1. A computer implemented method for providing sales of goods or services in conjunction with an organized event, comprising:
forming a ballot that includes at least one item for sale in relation to the organized event, the ballot further including information about the organized event;
providing access to a number of users via a computer network for indicating interest in the at least one item;
receiving indications of interest in the at least one item via the computer network to purchase the at least one item for a purchase price;
permitting a seller to set an overall price for the at least one item;
adding the purchase prices corresponding to the indications of interest to produce an overall purchase price; and
activating the sale of the at least one item upon the overall purchase price being equal to or greater than the overall price, such that each indication of interest is accepted as a sale for the purchase price.

2. The method according to claim 1, wherein the indication of interest is a monetary bid.

3. The method according to claim 1, further comprising:
permitting the seller to monitor the indications of interest for the at least one item; and
permitting the seller to set a lower overall price for the at least one item.

4. The method according to claim 2, further comprising accepting a number of bids at a predetermined price to activate the sale of the at least one item.

5. The method according to claim 1, wherein the at least one item is an entertainment related service.

6. The method according to claim 1, further comprising grouping indications of interest according to a particular status associated with specified products or service packages.

7. The method according to claim 1, further comprising activating the sale of the at least one item for the grouping of indications of interest.

8. The method according claim 1, further comprising establishing an interface specific to the organized event that provides the access to the number of users.

9. The method according to claim 8, further comprising establishing one or more of a user profile, account or user identifier for the number of users.

10. The method according to claim 9, further comprising permitting the number of users to upload media to the interface in relation to the organized event.

11. The method according to claim 8, further comprising hosting promotional material for the organized event on the interface.

12. The method according to claim 8, further comprising manipulating user information and relationship information that describes associations between two or more users in response to input from a user.

13. The method according to claim 8, further comprising providing an event identifier for the organized event that is accessible to a media communication device associated with a user at the organized event.

14. The method according to claim 10, further comprising uploading realtime media during the organized event.

15. The method according to claim 9, wherein the uploaded media is made selectively accessible to other users based on one or more of the user profile, account or user identifier.

16. The method according to claim 10, further comprising verifying a source of the uploaded media.

17. The method according to claim 16, further comprising comparing the uploaded media to known media data associated with the organized event.

18. The method according to claim 16, further comprising comparing GPS data related to the uploaded media with known GPS data associated with the organized event.

19. The method according to claim 1, further comprising receiving and storing commentary associated with the organized event.

20. A computer implemented system for providing sales of goods or services in conjunction with an organized event, comprising:
a processor that is operative to access and execute instructions from memory to:
form a ballot that includes at least one item for sale in relation to the organized event, the ballot further including information about the organized event;
provide access to a number of users via a computer network for indicating interest in the at least one item;
receive indications of interest in the at least one item via the computer network to purchase the at least one item for a purchase price;
permit a seller to set an overall price for the at least one item;
add the purchase prices corresponding to the indications of interest to produce an overall purchase price; and
activate the sale of the at least one item upon the overall purchase price being equal to or greater than the overall price, such that each indication of interest is accepted as a sale for the purchase price.

21. The system according to claim 20, wherein the processor is further operative to:
permit the seller to monitor the indications of interest for the at least one item; and
permit the seller to set a lower overall price for the at least one item.

22. The system according to claim 20, wherein the processor is further operative to establish an interface specific to the organized event that provides the access to the number of users.

23. The system according to claim 22, wherein the processor is further operative to permit the number of users to upload media to the interface in relation to the organized event.

24. The system according to claim 22, wherein the processor is further operative to provide an event identifier for the organized event that is accessible to a media communication device associated with a user at the organized event.

25. The system according to claim 23, wherein the processor is further operative to verify a source of the uploaded media.

26. The system according to claim 23, wherein the processor is further operative to receive and store commentary associated with the organized event.

27. A computer implemented method for participating in an organized event, comprising:
establishing an organized event by:
presenting event information; and
accepting bids to accumulate an overall value sufficient to meet a predetermined criteria;
providing an event identifier for the organized event that is accessible to a media communication device associated with an event user;
establishing a permissible communication link with the media communication device in response to receipt of the event identifier from the media communication device; and
receiving and storing media data associated with the event from the media communication device.
